(19) United States
(12) Patent Application Publication
(10) Pub. No.: US 2005/0010453 A1
(43) Pub. Date: Jan. 13, 2005

(54) Method and system for inverse life annuity

(76) Inventors: James D. Terlizzi, Wellington, FL (US); Timothy Joseph Trankina, Alpharetta, GA (US)

Correspondence Address: FOLEY AND LARDNER;SUITE 500, 3000 K STREET NW, WASHINGTON, DC, 20007, US

(21) Appl. No.: 10/616,458

(22) Filed: Jul. 10, 2003

(51) Int. Cl. G06F 17/60

(52) U.S. Cl. 705/4

(57) ABSTRACT

A computer based method for investing that includes causing the formation of an agreement for the transfer of benefits of an insured's life insurance policy to a first entity and the transfer of premium payment obligations of the insured's life insurance policy to the first entity or a second entity in exchange for periodic payments for a period of time to at least one of an owner of the life insurance policy and a third entity, wherein the period of time is based on at least one of a fixed period and the life of the insured.

### CROSS-REFERENCE TO RELATED PATENT APPLICATIONS

This application is related to provisional application entitled Mortality Linked Bond Obligation, by the same inventors (U.S. Provisional Patent Application Ser. No. ______, filed on Jun. 4, 2003), the contents of which are incorporated herein in their entirety.

### BACKGROUND OF THE INVENTION

Life insurance policies are a well established way for people, corporations, etc., to protect against the early demise of an important person. The concept behind a life insurance policy is that people who are important or who have responsibilities, financially or otherwise, to other individuals or groups of people or organizations, while planning to live for a sufficient period of time to fulfill those duties, may in fact die prior to that period of time. By way of example, parents plan on living at least until their children reach an age where they can lead their own lives and be self-supporting. Thus, parents with newborn children often purchase life insurance policies with their children identified as beneficiaries (i.e., the children receive money from the life insurance policy receive money from the life insurance policy at or after the death of the insured parents), the money received from the policy being used to raise, educate and otherwise provide for the children because the parents are not available to do so because they are dead. However, in many cases, the life insurance policy death benefits are not needed because the insured person outlives the critical period for which the insurance money was believed to be necessary. Again referring to the parental example, where the benefits of the life insurance policy were planned to be used to raise the children in the event of the parents premature death, the insurance policy would no longer be needed when, for example, their children have reached their 30s and are on their own. However, in the just described scenario, when the main reason for the insurance policy cease to exist, the insurance policy is usually still in effect and the premiums are still due to the carrier of the insurance policy (e.g., the life insurance company).

In this situation, the owners of the life insurance policy (e.g. the parents in the just mentioned scenario) are usually faced with the following alternatives. First, they can simply stop paying the premium payments and allow the policy to lapse. This would have the effect of freeing the parents from having to make future premium payments. However, any equity that they had in the life insurance policy would be lost and they would have no further benefits under the policy.

A second alternative could be to surrender the policy for its “cash-out” value. That is, many insurance policies have a contingency where the owners of the policy can go to the insurance company and basically surrender the policy (that is, free the insurance company from the requirement to pay a benefit upon the insured's death) in return for a cash payment. This does have the advantage of providing the owner of the policy with some form of cash benefit. However, in such a situation, the cash benefit could be quite small in comparison to the payout of the policy in the event of the death of the insured. By way of example and not by way of limitation, a life insurance policy that has as a death benefit a payment of $1 million to the beneficiaries may have a cash-out value of only $100,000.00, even though the owner of the policy has paid the premiums for this life insurance policy, for example, for 25 to 30 years, and there is a better than even chance that the insured person will become deceased within the next 10 to 15 years. Thus, exercising the cash-out option creates a windfall to the insurance company because they will have to only pay out $100,000.00 today, as opposed to having to pay out $1 million, 10, 15 or even 20 years in the future. Even taking into account the stock market boom of the late 90s and ignoring the stock market performance since 1999, such an investment would be considered quite profitable by most measures. Still further, when the amount of money that was paid to the insurance company in the form of premium payments by the owner of the policy is taken into account, the owner of the policy incurs a substantial loss on his or her investment (as compared to the benefits that would be paid as a result of the insured's death). Still, the cash-out value of the policy does leave the owner of the policy with something more than what they would have if they simply allow the policy to lapse, at least in the case where the owner of the policy is the insured.

A third alternative could be to continue to making premium payments to the policy and maintain the policy in-force. However, this does not provide the owner of the policy with immediate funds or money in the short run (or potentially ever, in the case where the owner of the policy is the insured person because the policy may not pay a benefit out until the insured person is dead). Further, this does not relieve the owner of the policy from the burden of making premium payments.

In view of the above, it is quite clear that there are, at least in some instances, insurance policies that would be quite valuable to an investor who has the ability to wait for a fixed period of time and/or an uncertain period of time based on, for example, the life expectancy of the insured person, to receive the benefits of the insurance policy if the investor is willing to assume or find someone to assume the premium payments of the life insurance policy and if the investor is willing to pay the owner of the policy something different than he would otherwise receive by following one or more of the just described options.

### SUMMARY OF THE INVENTION

In a first embodiment of the present invention, there is a computer implemented method for investing, comprising recording an indication of the formation of an agreement for the transfer of benefits of an insured's life insurance policy to a first entity and the transfer of premium payment obligations of the insured's life insurance policy to the first entity or a second entity in exchange for calculated periodic payments for a period of time to at least one of an owner of the life insurance policy and a third entity, wherein the period of time is based on at least one of a fixed period and the life of the insured.

In another embodiment of the present invention according to the first embodiment, the method further comprises determining prior to the formation of the agreement that the insured has a life impairment.

In another embodiment of the present invention according to the first embodiment, the period of time is based on a life style choice by the insured after the formation of the agreement.

In a second embodiment of the present invention, there is a computer based method for investing, comprising estimating the payments that would be received by the owner of a life insurance policy from a plurality of options, the plurality of plurality of options comprising selling the life insurance policy in exchange for a life settlement; an causing the formation of an agreement for the transfer of benefits of an insured's life insurance policy to a first entity and the transfer of premium payment obligations of the insured's life insurance policy to the first entity or a second entity in exchange for periodic payments for a period of time to at least one of an owner of the life insurance policy and a third entity, wherein the period of time is based on at least one of a fixed period and the life of the insured; and evaluating the differences between the payments that would be received by an insured from a plurality of options.

In another embodiment according to the second embodiment, the plurality of options also comprises surrendering the life insurance policy.

In a third embodiment of the present invention, there is a computer system, comprising a computing unit programmed with logic to determine the general amount of each payment in a group of periodic payments to be made for the life of an insured payable to a first entity based on the benefits of an insured's life insurance policy; and the premium payment obligations of the insured's life insurance policy.

### BRIEF DESCRIPTION OF THE DRAWINGS

FIG. 1 is a flow chart of a method according to one embodiment of the present invention.

FIG. 2 is a flow chart of a method according to another embodiment of the present invention.

FIG. 3 is a schematic of a typical computer system that may be used according to the present invention.

FIG. 4 is a block diagram showing the relationship between some of the entities according to one embodiment of the present invention.

### DETAILED DESCRIPTION OF THE PREFERRED EMBODIMENTS

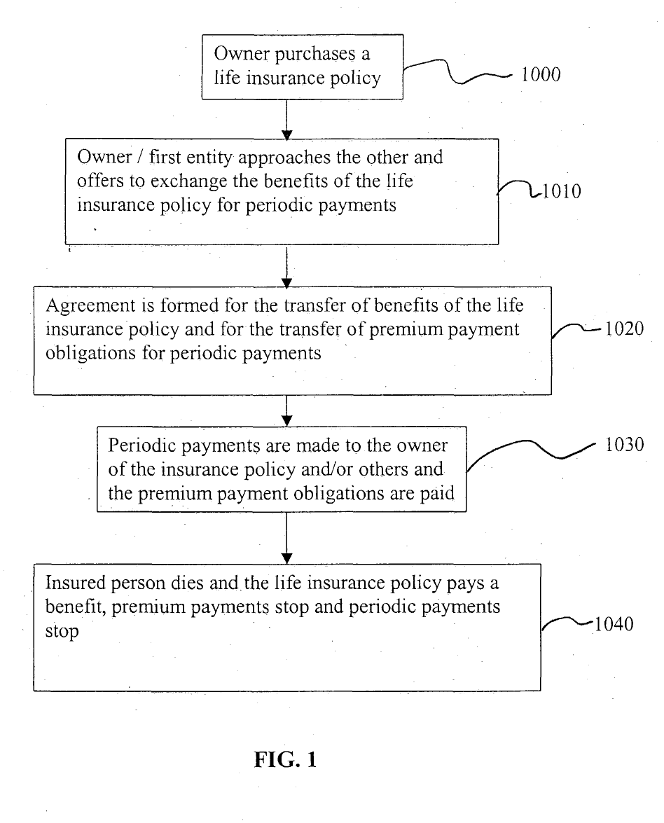

Referring to the flow chart of FIG. 1, there is a method of investing according to the present invention where an insured person, who has previously purchased a life insurance policy at 1000, thus making him or her an owner of the policy, approaches or is approached by a first entity at 1010 at which point an offer is made to exchange the rights to the benefits of the life insurance policy in return for periodic payments for the life of the insured. After working out the details of the agreement, such as the amount of each periodic payment, an agreement is formed at 1020 for the transfer of the present and/or future benefits of the life insurance policy (e.g. death benefits) and for the transfer of premium payment obligations in return for annuity/periodic payments to the owner. After the formation of the agreement 1020, periodic payments are made to the owner of the insurance policy and/or others and the premium payment obligations are paid by the first entity at step 1030. In some embodiments of the present invention, step 1030 can last for the life of the insured, which ends at step 1040, when the insured person dies, at which point the first entity stops paying premium payments, stops paying the periodic payments to the owner, and receives a payment from the carrier of the insurance policy in the form of a death benefit.

Embodiments of the present invention will now be discussed in further detail.

According to a first embodiment of the present invention, there is a method for investing comprising the formation of an agreement whereby the owner of a life insurance policy surrenders all or part of the benefits of that policy to another company, another party, etc. (hereinafter referred to as “the first entity”) in return for periodic payments to be paid to the owner of the policy and/or another party or parties, for a period of time. According to this embodiment of the invention, there is by way of example, a life insurance policy that is viewed as being no longer needed by its owner and/or considered less valuable than it once was by its owner. For example, due to changing circumstances, the owner of the life insurance policy finds that he or she is now in need of a stream of cash payments, and that receiving these payments would be more attractive than keeping the policy in force or exercising other available alternatives. In the first embodiment of the present invention, the life insurance policy is owned by the insured, the person on which the life insurance policy depends (i.e., the person upon who's death the life insurance policy will pay a benefit). However, in other embodiments of the present invention, the insured person is not the owner of the policy. By way of example and not by way of limitation, the insured person could be a key man in a company, and the company could own the policy. In such an embodiment, the company could be the beneficiary of the policy. That is, the company would receive the payout from the life insurance company that issued or is currently obligated to pay the benefits under the life insurance policy. In other embodiments, the company could have taken out the insurance policy and identified the insured's family as the beneficiaries of the policy.

The present method of investing can be practiced by forming an agreement between the owner of the life insurance policy and the first entity. By way of example only and not by way of limitation, this first entity could be a company that specializes in practicing the present invention, such as an insurance company, or other form of investment company. Further, by way of example, this first entity could be a company that specializes in settlement funding. Regardless of the form of the company, the first entity makes an agreement whereby the first entity assumes the obligations of paying the premium payments to keep the life insurance policy that is owned by the owner in effect, in return for the owner of the life insurance policy assigning or otherwise transfering the benefits, in whole or in part, of the life insurance policy to the first entity. It is noted that the present invention can be practiced in embodiments where the first entity is designated to receive the benefits of the life insurance policy, while a second entity is designated as being responsible for making the premium payments to keep the policy in force. This could be done, by way of example only and not by way of limitation, in a scenario where the two entities are companies that are closely held or at least substantially held by the same company or person, or where the first entity owns a portion of the second entity, and, for tax reasons or liability reasons, etc., it would be profitable to have one entity obtain the benefits under the policy while having the other entity take on the liability of keeping the policy in force. Still, it is noted that other embodiments of the present invention could be practiced wherein the entity assuming the benefits of the insurance policy is the same as the entity that agrees to assume the burden (that is to pay the premium payment obligations) under the agreement.

In yet other embodiments of the present invention, the obligation of paying the premium payments to keep the life insurance policy that is owned by the owner in effect is not transferred from the owner and/or another party, but instead remains with the owner, and/or is transferred to an entity other than the first and/or second entity. In such an embodiment, an agreement could be made wherein at least one of an owner of the life insurance policy and a third entity pays into an escrow account that is set up to pay the premium payment obligations of the insured's life insurance policy in the event that the premium payments are not made by the owner and/or another party. That is, the first and/or second entity can obtain assurance that the premiums will be paid on the insurance policy even though they are not making the payments. Indeed, some embodiments of the present invention can be practiced with anyone paying the premium payments, and some of these embodiments would include a safeguard to ensure that the premium payments are made. Other embodiments of the present invention could be practiced where some or all (temporally or quantitatively) of the periodic payments are withheld in the event that the premium payments are not made.

It is noted that the term “owner” is used throughout this application, and refers to the person and/or entity that owned the life insurance policy at the time of the agreement, and does not necessarily refer to the owner of the policy after the agreement is consummated. That is, the present invention contemplates both the outright sale of the insurance policy to the first and/or second entity at or around the time of the agreement, and the simple assignment of some or all of the rights under the insurance policy at or around the time of the agreement. Thus, in the former, the “owner” no longer owns the life insurance policy after the agreement, but can still be referred to as the owner, while in the latter, the owner still may own the life insurance policy.

The method according to the present invention is practiced by having the owner of the life insurance policy transfer at least apportion of his rights under the life insurance policy (or the rights of a beneficiary) away in return for a series of periodic payments for a period of time. In one embodiment of the present invention, these periodic payments could be paid to the owner of the life insurance policy. However, other embodiments of the present invention could be practiced whereby these payments are paid to someone other than the owner of the life insurance policy (hereinafter referred to as a third entity) such as for example the owner's only child. Still further, other embodiments of the present invention could be practiced wherein some of the periodic payments are paid to the owner and other periodic payments are paid to a third entity. It is also noted that additional entities could receive these payments as well (e.g., each of the owner's 5 children, etc.).

In using the phrase periodic payments, it is meant that a payment is made periodically over a period of time. By way of example only and not by way of limitation, a weekly payment, a monthly payment, a yearly payment, a quarterly payment, and a biannual payment would all be considered periodic payments. Also, payments that skipped some payment periods would also be included in the phrase periodic payments. Furthermore, payments according to a schedule with irregular intervals are also considered periodic payments according to the present invention.

Still further, when practicing an embodiment of the present invention where the owner of the life insurance policy and a third entity receives a periodic payment, the phrase includes payments that are sent to both the owner and the third entity periodically (i.e., both the owner and the third entity receive payments at or around the same time). For example, on May 1, a check would be mailed to both the owner and a third entity. In this invention, the periodic payments also include payments that are sent to an owner and a third entity but where periodic payments are first made to the owner and then periodic payments are made to the third entity. By way of example and not by way of limitation, periodic payments could be first made over the course of the first year to the owner (or over a portion of the first year to the owner), and then, in the second year, periodic payments could shift to the third entity. Still further by way of example, periodic payments could then shift back to the owner in the third year and could continue, for example, into the fifth year, after which the periodic payments could then shift back to the third entity. Still further by way of example, the present invention can be practiced whereby the owner first begins to receive periodic payments, and then the owner and the third entity receive periodic payments at the same time, and then the owner stops receiving the periodic payments but the third entity continues to receive the periodic payments and/or vice-versa. As yet another example, the third entity could begin to receive the periodic payments before the owner. Thus, any form of periodic payment that is made to the third entity and/or the owner constitute periodic payments for a period of time to at least one of an owner of the life insurance policy and a third entity.

As can be seen, the periodic payments could be made payable to the owner and/or the third entity or others for a period of time. This period of time could be based on a number of factors. By way of example only and not by way of limitation, the period of time could be a fixed period determined at or in close temporal proximity to the formation of the agreement according to the present invention to transfer the benefits and obligations of the life insurance policy. In other embodiments of the present invention, this period of time could be based on the life of the insured. By way of example, the agreement could stipulate that the periodic payments would be made to the owner up until the time that the insured person died. Such a practice might be analogous to paying life insurance premiums up until the insured person dies, as usually, premium payments are not made after the insured person dies. (It is noted that some life insurance policies do have a clause wherein the requirement to pay premium payments to maintain the life insurance policy stops after the insured reaches a certain age. Thus, the just mentioned example might not be exactly analogous with every form of life insurance policy.)

Still further, the period of time could be based on a variable time as well. By way of example and not by way of limitation, the present invention could be practiced where a variable period of time results from an agreement, where the periodic payments would be made for the life of the insured, but in the case of a significant event beyond the control of the first and/or second entity, the period of time of the periodic payments would be substantially shortened and/or the payments would be immediately stopped or stopped at a certain date upon such event. For example, if interest rates radically increase or decrease (by an amount, for example, that can be predetermined and identified in the agreement), the periodic payments could be suspended. Still further by example, in the just mentioned scenario, if interest rates return to a stable level, the periodic payments could again take effect.

Thus, the present invention could be practiced using a variety of time periods that constitute periods of time. These periods of times are not limited to the just mentioned examples, as the present invention can be practiced with time periods based on virtually any appropriate time scale that is agreeable to the parties to the agreement and/or any other necessary party or entity.

As noted above, the present invention can be practiced wherein the periodic payments are made for a period of time to at least one of an owner of the life insurance policy and a third entity. The present invention can also be practiced, by way of example, in combination with a payment of at least one lump-sum payment to either the owner of the life insurance policy or a third entity, or a lump-sum payment to both the owner of the policy and a third entity, or a lump-sum payment made to an entity other than the owner and the third entity, wherein the third entity is receiving periodic payments. Still further by example, the lump-sum payment could be made only to a third entity and not the owner, where the owner of the life insurance policy receives periodic payments and the third entity only receives the lump-sum payment. Still further by example, the present invention could be practiced whereby the owner only receives a lump-sum payment and a third entity or entities receive periodic payments. In yet another example, the present invention could be practiced wherein an entity other than the owner and the third entity only receives a lump-sum payment. Thus, any combination of payments or types of payments can be utilized to practice the present invention as long as a periodic payment is made to someone.

In yet further embodiments of the present invention, this lump-sum payment is made in very close temporal proximity with the consummation of the agreement for the transfer of benefits according to the present invention. By way of example only and not by way of limitation, when the owner of the insurance policy or the owner's agents meets with the entity or entities that are assuming the liability and/or identified to receive the benefits of the life insurance policy to sign the agreement, a check representing a lump-sum payment could be given to the owner when the agreement is signed. Alternatively or in addition to this, a check representing a lump-sum payment could be given to the owner within a few days of the consummation of the agreement.

As part of the formation of the agreement according to the present invention, all or part of the obligations to pay premium payments for the life insurance policy are transferred from the owner or other responsible paying party to another entity (e.g., the first and/or second entity). In the first embodiment of the present invention, these premium payment obligations include the periodic premium payments that are required to maintain the life insurance policy. In one embodiment of the present invention, these periodic premium payments include payments which could be based on, by way of example, either a monthly, a quarterly, and an annually payment schedule, and could also be based on a weekly or semi-annual, or biannual payment schedule as well. Indeed, any periodic or non-periodic premium payment that is required by the issuer of a life insurance policy to maintain the life insurance policy in force would be covered by the phrase periodic premium payments.

Other embodiments of the present invention include the formation of a second agreement which could be separate from the first agreement. This second agreement could entail the assignment of some or all of any rights to the periodic payments and/or lump sum payments that the owner or other entity might be entitled to resulting from the first agreement to another entity. By way of example and not by limitation, the owner could form a first agreement wherein the first agreement includes a provision that the owner receives $10,000 per month from the first entity. In a second agreement, the owner could then agree to assign $1,000 per month of the $10,000 to another entity. This could be, for example, an assignment to the owner's child or to the owner's grandchild, etc. This might be desirable for tax purposes or for either estate and/or income tax purposes, etc. In other embodiments, this second agreement could result in the assignment of say, the first five payments in a given year to the assignee, after which the owner could then receive the remaining seven payments, in the case where the periodic payments are paid per month. Still further, in other embodiments, the entire $10,000 per month could be assigned to another entity.

The periodic payments according to some embodiments of the present invention are equal to each other or substantially equal to each other. That is, for example, the payment received in January, for a monthly periodic payment schedule, would be the same as that received in March of the same year, and would also be the same as that received in the same months ten years hence. (In the event that the insured is still alive and/or the fixed period, of time has not elapsed or some other event has not occurred that would serve to stop the payments.) However, other embodiments of the present invention can be implemented, wherein the periodic payments decrease over time or, alternatively, where the periodic payments increase over time. Still further by example, embodiments of the present invention could be practiced wherein the periodic payments decrease over time and then increase over time and then decrease over time and then stay the same for a period of time, after which they could either again increase or decrease or stay the same. That is, the present invention could be practiced with a wide variety of payment schedules.

In the case where payments decrease or increase over time, some embodiments of the present invention could be practiced whereby the periodic payments decrease uniformly or substantially uniformly over time. That is, for example, every month, the payments could be reduced by $10.00. Or alternatively, all of the monthly payments in a given year could be equal to $10,000.00, and then, in the following year each monthly payment could be $9,500.00, and then, in the next year each payment could be $9,000.00. This would work in reverse in the case of increasing payments.

It can be seen that an early death of the insured person results in an early payment to the entity or entities receiving the benefits of the life insurance policy under the agreement (or their assigns). The corollary to this is that an early death of the insured person will usually result in the termination of the requirement to pay life insurance premium payments to the issuer of the insurance policy (or their assigns). Thus, in this regard, an early death of the insured person both reduces the number of payments that the first/second entities must make, both to the insurance company and to the owner of the policy, and can thus result in an immediate cash windfall. To this end, embodiments of the present invention could be practiced by forming agreements with owners of life insurance policies where the insured has some form of life impairment. By way of example and not by way of limitation, if the insured person has recently been diagnosed with diabetes or Alzheimer's, for example, there is a higher likelihood that this person will die sooner than a similarly situated person who has a medical status the same as or substantially the same as the average person at that person's age. That is, the present invention could be most profitable to the first entities when practiced with insured people who are “worse off,” medically speaking, than a similarly situated person in their age group.

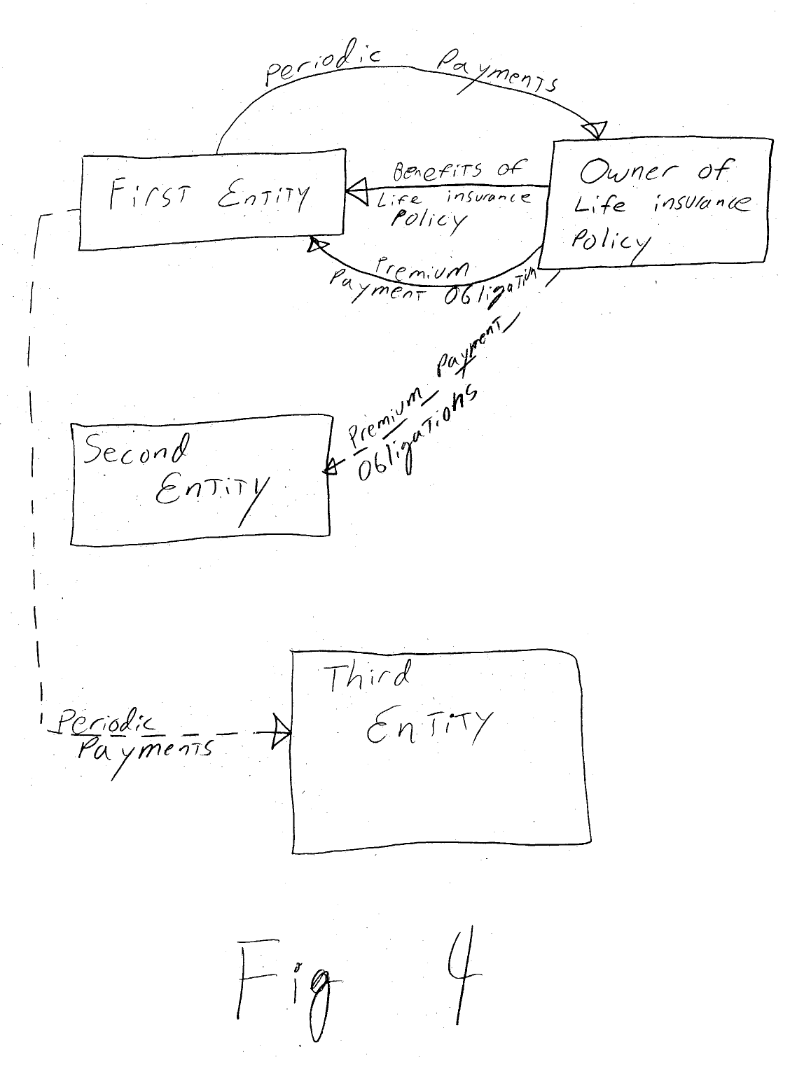

FIG. 4 shows a diagram representing the interactions among the various entities of one embodiment of the present invention.

As noted above, the entities paying the periodic payments and/or who are responsible to maintain the life insurance in force might find it to their advantage that the insured person expires sooner rather than later. To this end, the present invention could be practiced by evaluating the life expectancy of the insured person prior to forming the agreement. This could be done in a variety of ways, one of which is to identify the insured person's life expectancy based on his rated age. This is illustrated by the following example (which is not by way of limitation): In 1991, Mr. Smith, then 64 years of age, bought a universal life insurance policy with a death benefit of $1 mil. from life Insurance company. It is now almost 13 years later and Mr. Smith, presently 77 years of age, has suffered a degradation in his health. In fact although his chronological age is 77 years, he has a “rated age” of 81 years. The rated age reflects the health conditions he now suffers from which may cause the insurance community to look at him and price products for him as though he were 4 years older.

In determining the life expectancy of the insured, one method that can be used is to use a method that is generally the same as the method that was used to underwrite the insured's life insurance policy. That is, when the insured purchased the life insurance policy, the issuing insurance company probably utilized a life actuarial estimation method to estimate how long the insured would live, and thus determine, by way of example, what the premium payments should be so as to return a profit. According to the present invention, a generally similar method would be used to estimate the insured's current life expectancy. This could take into account the insured's current medical condition. By way of example, an insured person who has contracted Alzheimer's or who has been diagnosed with Alzheimer's should, statistically speaking, have a shorter life expectancy than a similarly situated person who has not contracted the disease. In still other embodiments of the present invention, the life expectancy of the insured is determined using at least one method that is generally the same as one or more of the commonly accepted methods used to currently underwrite life insurance policies. That is, successful insurance companies usually have standard procedures that they follow to estimate the life expectancy of a person. While these methods can vary from one insurance company to another, the methods are still generally the same, and thus the end result should not differ between the systems by a significant amount. Still further, many insurance companies utilize multiple systems whereby the estimated life expectancies are averaged and/or normed in some manner, or the shortest life expectancy is relied on to error on the side of caution (e.g., a life insurance policy would probably identify the shortest life expectancy because that would be the one that would result in the highest financial burden to the insurance company). Thus, the present invention could utilize common methods or similar methods to establish such policies. Still further, embodiments of the present invention could utilize such methods and also take into account the insured's medical condition, wherein the insured has an impaired life (e.g., Alzheimer's). However, in other embodiments of the present invention, a novel or uncommon life estimation method could be used.

Some methods that can be utilized with-the present invention to estimate the life expectancy of an insured comprise determining the insured's current age which could, but does not necessarily require, obtaining a certified copy of the insured's birth certificate, determining the sex of the insured (because, for example, it is known that males in the United States, statistically speaking, have shorter life expectancies than females, although in other situations, it is possible that males could have a longer life expectancy depending on whether or not there are other ailments or lifestyle factors that could influence the life expectancy estimation), determining the present medical condition of the insured, and identifying the presence or absence of medical conditions among at least one member or more than one member of the insured's family (e.g., identifying whether the insured's mother and/or father had a heart attack, skin cancer, heart disease, etc.). Further, a method used to determine the life expectancy of an insured could also include identifying the presence or absence of lifestyle choices previously made by the insured that are statistically linked to a shortened life expectancy. By way of example only and not by way of limitation, an insured who smokes two packs of cigarettes a day, statistically speaking, should have a shorter life expectancy than a similarly situated person who does not smoke. Still further by way of example, an insured person who drinks alcohol in an abusive and problematic manner should, statistically speaking, have a shorter life expectancy than a similarly situated person who abstains from alcohol consumption. Thus, the present invention includes a method or methods to estimate the life-expectancy of the insured, and the present invention can be practiced using any method that can accurately or otherwise reasonably estimate the life expectancy of the insured, wherein reasonable accuracy would still allow the first/second entities to receive an acceptable profit per agreement (wherein profits include, but one not limited to, the compounding effect resulting from monies saved by the death of the insured).

One embodiment of the present invention includes practicing the method of investing wherein at least one of the insuring entities is licensed to issue annuities By way of example and not by limitation, the exchange of the life insurance policy for the periodic payments could qualify as a section 1035 exchange under U.S. Tax Law. Still further, some embodiments of the present invention could be practiced wherein at least one of the contracting entities is a licensed and rated insurer, where licensed and rated insurer; means that the entity is licensed and rated so that he or she can sell insurance in at least one of the fifty states of the United States. However, in other embodiments of the present invention, a licensed and rated insurer could include the licenses and ratings that are necessary and/or at least advisable and/or at least desirable to have in jurisdictions outside of the United States (e.g., the nations of Europe, Asia, etc.).

Some embodiments of the present invention can be practiced utilizing a payment schedule or payment regime whereby all or part of the periodic payments are based on a fixed rate of return. That is, the payments could be based on, by way of example, an investment portfolio that will provide a fixed rate of return. By way of example and not by limitation, payments for a given year could be linked to the performance of a one-year treasury bill issued on a given date, and thus the payments will be fixed at least, for example, one year, because the yield on that one-year treasury bill would be constant over the one year if it was bought at the beginning of the year. Still further, some of these fixed rate of returns could be guaranteed rates of returns. That is, as in the just mentioned treasury bill example, a guarantee can be made to one or more of the recipients of the periodic payments that their payments will equal at least a certain amount because it will be known what interest will result from the investments. Still, in other embodiments of the present invention, some or all of the periodic payments can be based on a rate of return that can be linked to an investment security (by way of example, trading on the 5 year treasury note), but also the recipient of the periodic payments can be guaranteed that the periodic payments will not be below a certain amount. That is, they could be given a guarantee of a minimum payment, with the possibility of higher payments. Still, in other embodiments of the present invention, the fixed rate of return will be a guaranteed minimum rate of return that could increase, but would not increase more than a pre-determined amount and/or percentage. By way of example, if the periodic payments are linked to 10-year treasury bond trading, and trading results in a return that is in excess of an expected amount, the recipient of the periodic payments might still only receive a percentage of the difference between the guaranteed amount and the total return on the investment. Thus, after subtracting management fees and taxes, etc., the remainder would be a windfall to the first/second entity. Conversely, in the event that the investment security results in an investment yield that is below the amount that would be paid in the periodic payments, the recipients of the periodic payments could still receive a minimum amount. Still further, in other embodiments of the present invention, the periodic payments can be structured so that the fixed amount will only be a minimum amount and it will be possible for the recipient of the periodic payments to receive a higher amount depending on the yield of the investment. By way of example, 50% of the above-mentioned windfall profits could be paid to the recipient of the periodic payments.

Still further, in other embodiments of the present invention, some or all of the periodic payments are based on a variable rate of return. By way of example, some or all of the periodic payments can be based on the S&P 500, wherein an increase in the S&P 500 could result in an increase in the amounts of some or all of the periodic payments, and, conversely a decrease in the S&P 500 (including or not including dividend payments) could result in a decrease in the amount of the periodic payments and/or the possible elimination of one or more of the periodic payments.

In yet other embodiments of the present invention, there is a payment regime wherein the periodic payments that are based on a variable rate of return are based on a portfolio of investment securities or the prime interest rate; or a combination of the two. For example, the rate of return could be directly linked to the prime interest rate. Thus, if the prime interest increases, the amount of a given periodic payment would increase, and if the prime interest rate decreased, the amount of a given periodic payment would decrease. By basing the payments on both a portfolio of stock securities and the prime interest rate and/or bonds, it could, be possible to balance the risks in the stock and bond market, resulting in a safety factor for some or all of the parties to the agreement (or their assigns).

In another embodiment of the present invention, there is yet another agreement formed with, by way of example and not by limitation, another insurance company, or any other entity (hereinafter referred to as the “fourth entity”), wherein the fourth entity agrees to pay at least one of the first/second entities money at the expiration of a time period during the life of the insured. For example, an insurance company could agree to write a policy whereby the, entities would receive a certain amount of money from the fourth entity in the event that the insured is not deceased by a certain date, thereby insuring that they will have funds available to continue paying the periodic payments and/or to continue making the premium payments. This embodiment of the present invention can provide a measure of insurance for the contracting entities. As can be seen in the following example, if the insured is 70 years old at the time of the agreement, and he is expected to only live until 75 based on life actuarial sciences, and he in fact lives until 95, and the entities are obligated to continue making periodic payments to the insured and/or another entity during the life of the insured and/or to continue making premium payments, the first/second entities could incur a substantial loss on their investment. By contracting with the fourth entity, this can insure that the entity's losses will be only limited to a certain amount. Other embodiments of the invention could be practiced where the insurance even allows the entities to turn a profit. Depending on how the payments schedules are arranged, this provides a level of certainty and/or finality to the first/second entities. Still further, other embodiments of this invention can be practiced whereby this fourth entity agrees to simply assume the responsibility of making some or all of the periodic payments and some or all of the premium payments. That is, the first/second entities could simply “walk away” from the agreement with the owner of the insurance policy, having no further obligations under the agreement because they have legally and legitimately contracted away their obligations under the agreement with the fourth entity.

In yet another embodiment of the present invention, there is a method of determining whether or not the insured person is deceased, or at least determining that there is an increased likelihood that the insured person is deceased, based on the disposition, or lack thereof, of a negotiable instrument issued to the insured resulting from the agreement transferring the benefits of the life insurance policy. In one embodiment of this invention, the insured person is the owner of the life insurance policy and receives periodic payments from the first/second entity per the terms of the agreement. In an another embodiment of the present invention, the owner of the policy is not the insured, however the insured person still receives a periodic payment from the first/second entity. In both embodiments, the periodic payment can comprise the entire payments under the terms of the agreement, or only a portion of the payment under the terms of the agreement.

In this regard, some embodiments according to the present invention include, in some form or another, a method where the insured person against whose life the life insurance policy is based receives some form of negotiable instrument that requires his or her signature for the negotiable instrument to be exchanged, either for cash, or for endorsement to another person or company in lieu of payment. The idea being that if the insured person is dead, the insured person cannot endorse the, negotiable instrument. Thus, the negotiable instrument will probably not be cashed or exchanged or otherwise put into the stream of commerce, and therefore, the check will not be cashed and/or returned to the person or entity who wrote the check after it has been cashed. By way of example, if the insured person has been receiving periodic payments in the form of a check for the past 25 months, and at no time during the 25 months did he wait more than 45 days after the mailing date to cash the check, then if 60 days elapses and the check has not been cashed, there is an increased likelihood, however small, that something has happened to the insured person which could include the death of the insured. Some embodiments of this method can rely on the principal that it would be fraud for someone other than the insured to sign the check so that it can be cashed, and thus people tend not to sign someone else's signature on the check for the purposes of cashing a check. Thus, according to this embodiment of the invention, the entity that is entitled to receive life insurance benefits upon the death of the insured person can determine that there is an increased possibility that the insured is dead, and the entity can undertake efforts to verify such an event (or to determine that the insured is still alive). This provides at least one advantage, because it might be considered somewhat unseemly for the recipient of the benefits of the insurance policy to periodically contact the insured person and ask if he is or she is dead. Still further, such indication can be determined faster with fewer resources.

Other embodiments of the present invention can disregard the historical check cashing patterns of the insured in lieu of a predetermined fixed period of time, after which it can be assumed that there is an increased likelihood of the insured's death. That is, by way of example, a time based on, say, for example 75 days, could be selected. If 75 days have elapsed and the check has not been cashed or returned to the check writing entity, it can be assumed that there is an increased likelihood that the insured is dead, and further investigations as to the status of the insured can be commenced. Still further, the present invention can be practiced by simply relying on the fact that the check has become expired. That is, the check has not been cashed within the “void” period printed on the front of the check. Still other embodiments of the present invention can utilize a combination of the historical patterns of check cashing policy and/or a predetermined set period of time between mailing and cashing of the check or return of the cashed check or lack of a cashing of the check, as is desirable. It is noted that the present invention can be practiced by utilizing a historical trend that changes over time. For example, early in the periodic payments, the insured always cashes his or her check within 30 days, whereas during later periods of the periodic payments, the insured takes 45 days or 60 days, etc. Thus, the system could be modified in process to account for this new change in check cashing patterns. Other embodiments of the present invention can be practiced in conjunction with any appropriate way to identify the increase likelihood that the insured is dead based on a delay in cashing the check.

In other embodiments of the present invention, there is a method of identifying whether or not there exists an increased likelihood that the insured has died based on inspecting the signature representing the endorsers signature of the check. For example, if the check is made out to Mr. Smith, and previous checks made out to Mr. Smith are signed in certain manner indicative of Mr. Smith's signature, and then a check is cashed where the signature of “Mr. Smith” looks different in some form or another, as could be identified by the handwriting analysis and signature validation arts, it could be determined that there is an increased likelihood that Mr. Smith is no longer signing his checks, and thus there is an increased likelihood that Mr. Smith is deceased. Thus, independent of the time between the mailing of the check and the cashing of the check, there is a way to validate whether or not there is an increased likelihood that the insured deceased based on information relating to a check mailed to the insured. Still further, it could suffice to simply validate the insured's signature prior to or at the time of signing the agreement, and then utilize that signature for comparison to the signature on the check and determine that it is the same signature or a substantially similar signature. This would, for example, help ensure that regardless of who endorsed the first check, the insured is the person endorsing the checks.

It is recognized that the present invention is not the only way to dispose of an unneeded life insurance policy. As noted above, the owner of a life insurance policy has the ability to simply cash in his policy and receive a payment from the insurance company in the form of a predetermined amount. Because the owner of an insurance policy has at least one other option available to him or her, an embodiment of the present invention includes estimating the payments that would be received by the owner (and/or the beneficiaries) of a life insurance policy from a plurality of options.

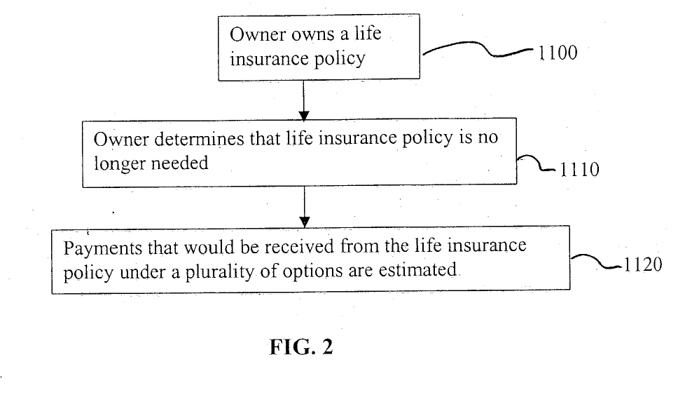

In this regard, according to another embodiment of the present invention, schematically illustrated in FIG. 2, there is a method of investing where an owner who owns a life insurance policy at 1100 determines at 1110 that he or she no longer needs or may no longer need the life insurance policy. Thus, at 1120, payments that would be received by dispositioning the life insurance policy under a plurality of options, including forming an agreement according to the present invention, are estimated. In a step not illustrated in FIG. 2 (a step that is not practiced in many embodiments of the present invention, although can be practiced in other embodiments of the present invention), the owner of the policy selects an option based on maximizing the payments that would be received from the dispositioning of the life insurance policy. However, it is noted that in other embodiments of the present invention, the option selected does not include selecting that option to maximize the payments that would be received from the dispositioning of the life insurance policy.

One of the options would include comparing the payments that would be received resulting from an agreement according to the present invention. For example, the payments that would be received resulting from an agreement according to this invention (or a present value thereof) could be compared to that received by simply surrendering the life insurance policy. Still further, in other embodiments, the received payments from the agreement according to the present invention could be compared to the payments that would be received by selling the life insurance policy in exchange for a life settlement, as is commonly understood by one of ordinary skill in the art. Still further, other embodiments of the present invention could include comparing the payments that would be received resulting from the agreement to the savings that would result from simply allowing life insurance policy to lapse.

The present invention also contemplates practicing one or more of the above discussed embodiments or variations thereof with the issuance of a bond or other obligation. By way of example only and not by way of limitation, any or all of the embodiments of the present invention can be practiced in conjunction with any or all of the embodiments of U.S. Provisional Patent Application No. ______ entitled Mortality Linked Bond Obligation to the same inventors, filed on Jun. 4, 2003, which, as noted above, is incorporated herein by reference in its entirety. For example, the money needed to make some or all of the periodic payments could be financed by a life annuity purchased with proceeds of a bond that has as security the death benefit of the insurance policy, and interest on the bond could likewise be paid by the proceeds (whether paid directly or by assignment) from the life annuity.

In yet other embodiments of the present invention, the method of investing is practiced by transferring the benefits of a plurality of life insurance policies. By way of example and not by limitation, companies sometimes purchase life insurance policies for many or all of their employees, the benefits of the policies being payable to the company. This is sometimes referred to as “janitor insurance.” The present invention can be practiced by transferring the benefits of some or all of the plurality of policies according to the embodiments discussed above or below or other embodiments. By way of further example and not by limitation, if a company has 10 employees, and it has taken a life insurance policy out on each of the employees, an agreement can be formed transferring the benefits of the 10 (or fewer) policies to a first entity and the transfer of premium payment obligations of those policies to the first entity or the second entity in exchange for periodic payments to, for example, the company.

The present method of investing also contemplates embodiments that include comparing other options that would be available to the owner of a life insurance policy. That is, embodiments of the present method of investing could be practiced where the payments that would be received from the formation of the agreement are compared to any other form of payment or other benefit that would be received by disposing of the life insurance policy in any manner available to the owner. It is noted that the present method of investing can be practiced by comparing more than one option to the option of receiving payments resulting from an agreement according to the invention. Indeed, embodiments of the present invention could be practiced by comparing the payments that would be received by forming an agreement according to the invention to any or all of the just mentioned options. It is noted that one of the available options to the owner of a life insurance policy would be to simply maintain the life insurance policy in its effect. That is, do nothing.

The present invention also includes embodiments of the method for investing wherein the owner of the life insurance policy compares the options available to him, including an agreement according to the present invention, while taking into account the effect of taxes. Taxes include, but are not limited to, estate taxes, the absence of estate taxes, the effect of income taxes and/or the absence of income taxes for monies that would be received (or not received) from payments resulting from the selection of one or more of the options available to the owner of the life insurance policy. By way of example and not by way of limitation, an owner of a life insurance policy could take into account the estate taxes that would be paid by the owner's heirs in the event that the owner chooses a life settlement option and receives money from that option, and that money is later inherited by his children.

The present invention also comprises a computer system that can be used to practice the present invention in whole or in part.

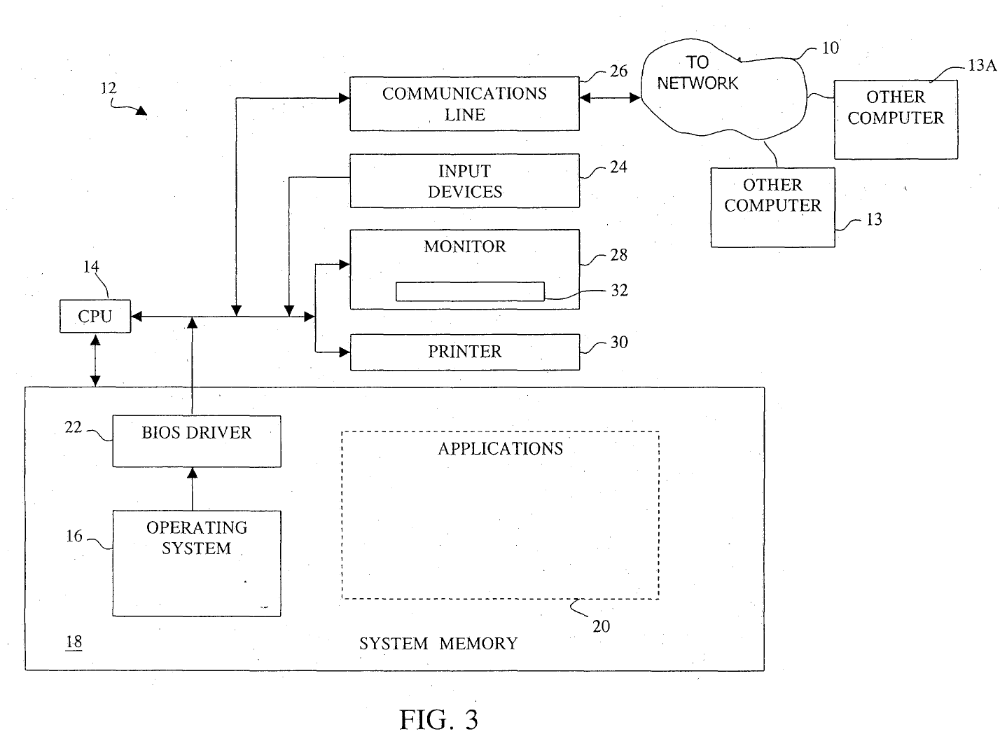

FIG. 3 shows a diagram showing the components of a general purpose electronic network 10, such as a computer network. The computer network can be a public network, such as the Internet. As shown in FIG. 1, the computer system 12 including a central processing unit (CPU) 14 connected to a system memory 18. The system memory 18 typically contains an operating system 16, a BIOS driver 22, and application programs 20. In addition, the computer system 12 contains input devices 24 such as a mouse or a keyboard 32, and output devices such as a printer 30 and a display monitor 28, The computer system generally includes a communications interface 26, such as an ethernet card, to communicate to the electronic network 10. Other computer systems 13 and 13A also connect to the electronic network 10 which can be implemented as a Wide Area Network (WAN) or as an internetwork such as the Internet.

One skilled in the art would recognize that the above describes a typical computer system connected to an electronic network. It should be appreciated that many other similar configurations are within the abilities of one skilled in the art and it is contemplated that all of these configurations could be used with the method of the present invention. Furthermore, it should be appreciated that it is within the abilities of one skilled in the art to program and configure a computer system to implement the method steps of the present invention, discussed herein.

Furthermore, the present invention contemplates providing computer readable data storage means with program code recorded thereon for implementing the method steps described further herein.

In one embodiment of the present invention that utilizes a computer system, there is logic to determine the approximate and/or exact amount of each payment in the group of periodic payments, wherein these payments are based on the benefits of a life insurance policy and the premium payment obligations of the insured life insurance policy. Thus, a benefit to practicing this embodiment is that the return on investment for the investor could be more easily determined because the benefits of the life insurance policy and the premium payment obligations of that life insurance policy can be managed in a data base and thus manipulated to estimate returns on investment. Still further, this system could be used to estimate the appropriate amount in each payment in the group of periodic payments that will provide for a given return on investment with the assumption that the insured will live a certain number of years and/or for a fixed period of time as described above. The logic used to determine the general amount of each payment in the group of periodic payments can be based on the life expectancy of the insured. That is, logic can be used to estimate how much money should be paid out in periodic payments in order to obtain a profitable and acceptable return of investment, assuming that the insured will only live to his or her expected life expectancy. Still further, in other embodiments of the present invention, logic includes an algorithm to estimate the general amount of each payment in a group of periodic payments to be made in the event that the insured lives beyond his or her life expectancy. By way of example, logic can be used to estimate the payments that would be required to return an acceptable investment in the event that the insured lives for, say, six months, one year, eighteen months, two years, three years, four years, etc., beyond his or her life expectancy. In further embodiments of the present invention, this life expectancy could be based on a rated age of the insured, as described above in further detail. Thus, this would permit the computer system of the present invention to estimate the periodic payments to be made by simply inputting the rated age of an insured and comparing the difference to that rated age and a generic number based on the sex of the insured, or alternatively not based on anything (for example, in the event that the rated age takes into account the sex of the insured), so that, by way of example, the computer system can estimate the payments without requiring a computer system that must rely on and/or be compatible with life actuarial sciences (e.g., the computer system can be a “dumb” system, because the life estimating portions of the method would be practiced for example, by a separate'subcontractor).

The computer system according to the present invention can also comprise logic to determine the general amount of a lump sum payment to be made to an entity that would receive the payments under the agreement according to the present invention which could be based on, again, the benefits of an insured's life insurance policy and the premium payment obligations of the insured's life insurance policy. As with the logic of the above mentioned computer systems used to estimate the general amount of each payment in a group of periodic payments, the same or similar logic could be used to estimate the lump sums or a plurality of lump sums that would be paid and still allow the contracting entity to reap an acceptable return on investment. Again, as with the logic to determine the periodic payments, the logic used to determine the general amount of the lump sum payments could be based on the life expectancy of the insured, for example.

As noted above, the present invention includes periodic payments that increase or decrease over a period of time. To this end, a computer system can be configured where the logic used includes algorithms that increase or decrease the general amount of each periodic payment over time according to one or more variables, including but limited to, a preset payment increase/reduction schedule, the prime interest rate, the S&P 500, etc. It is also noted that some embodiments of the invention can include a computer system which estimates these payments, whether the payments be periodic or lump sum, etc., to more than just one entity, as would be the case in the scenario where the owner of the life insurance policy and a benefited other party (e.g. the owner's son) receives periodic payments and/or lump sum payments as well.

The present invention also includes embodiments in which more than one entity could receive periodic payments. Because of this, some embodiments of the present invention comprise a computer system that includes logic to direct at least one of the payments of the periodic payments to a first entity and logic to direct at least one of the payments of the periodic payments to a second entity, wherein these payments can include both payments to the first, second and additional entities as well in a given period payment (e.g., the periodic payment could be split between the two). Still further, embodiments of the present invention could include computer systems that direct periodic payments first to one entity and then to another entity. Such a computer system could also include payments to a first and second entity at the same time. Still further, in keeping with the embodiments of the present invention, where a lump sum payment is paid in addition to the periodic payment, there is a computer system according to the present invention that includes logic to direct payment of the lump sum payments to a first entity and/or a second entity, or other entities.

Still other embodiments of the present invention can be practiced by inputting at least some pertinent information relating to the agreement (whether consummated, planned to be consummated, or considered as an option) according to the present invention into a computer terminal. By way of example and not by limitation, a computer terminal could simply include or be limited to a “dumb” monitor linked to a mainframe that could be or is not located in the same building or same region with the computer terminal, and could also include a personal computer. This information could then be transferred to a computer. By way of example and not by way of limitation, this computer could be a mainframe computer located in the same building or in another building or in another region. In other embodiments of the present invention, the computer terminal could be located in one region separate from the region in which the computer to which the information is transferred is located. Indeed, in some embodiments of the present invention, the computer terminal could be located in one country and the computer to which the information is transferred could be located in another country. Thus, some embodiments of the present invention could include simply putting pertinent information about the agreement of the invention into a keyboard.

Embodiments within the scope of the present invention include program products on computer-readable media and carriers for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The invention is described in the general context of method steps which may be implemented in one embodiment by a program product including computer-executable instructions, such as program modules, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention is suitable for being operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices

It should be noted that although the flow charts provided herein show a specific order of method steps, it is understood that the order of these steps may differ from what is depicted. Also, two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming, techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. A computer implemented method for investing, comprising:
recording an indication of the formation of an agreement for the transfer of benefits of an insured's life insurance policy to a first entity and the transfer of premium payment obligations of the insured's life insurance policy to the first entity or a second entity in exchange for calculated periodic payments for a period of time to at least one of an owner of the life insurance policy and a third entity, wherein the period of time is based on at least one of a fixed period and the life of the insured.

2. The method of claim 1, further comprising, determining prior to the formation of the agreement that the insured has a life impairment.

3. The method of claim 1, wherein the period of time is based on a life style choice by the insured after the formation of the agreement.

4. The method of claim 1, wherein the premium payment obligations of an insured's life insurance policy are transferred to the first entity.

5. The method of claim 1, further comprising paying at least one lump-sum payment to at least one of the owner and a third entity.

6. The method of claim 5, wherein the one-lump sum payment is made in close temporal proximity with the consummation of the agreement.

7. The method of claim 1, further comprising calculating and paying a plurality of lump-sum payments to at least one of the owner and a third entity.

8. The method of claim 1, wherein the periodic payments are made to the owner and a third entity or to the owner and a plurality of entities.

9. The method of claim 1, wherein the premium payment obligations include the periodic premium payments to maintain the life insurance policy.

10. The method of claim 1, wherein the periodic premium payments include payments based on at least one of a monthly, a quarterly and an annual payment schedule.

11. The method of claim 1, further comprising recording the formation of a second agreement, wherein the owner assigns at least a portion of any rights to the periodic payments to another entity.

12. The method of claim 1, wherein the periodic payments are substantially equal to each other.

13. The method of claim 1, wherein the periodic payments are equal to each other.

14. The method of claim 1, wherein the periodic payments are serially paid to a plurality of entities.

15. The method of claim 1, wherein the periodic payments decrease over time.

16. The method of claim 1, wherein the periodic payments increase over time.

17. The method of claim 1, wherein the periodic payments increase or decrease substantially uniformly over time.

18. The method of claim 1, further comprising evaluating and calculating the life expectancy of the insured prior to forming the agreement.

19. The method of claim 18, wherein the life expectancy of the insured is based on the rated age of the insured.

20. The method of claim 18, wherein the life expectancy of the insured is determined using at least one method that is generally the same as the life expectancy estimation methods used to establish the insured's life insurance policy while taking into account the insured's current medical condition.

21. The method of claim 18, wherein the life expectancy of the insured is determined using at least one method that is substantially the same as the commonly accepted methods used to underwrite life insurance policies.

22. The method of claim 18, wherein the life expectancy of the insured is determined using at least one method that is generally the same as the life expectancy estimation methods used to underwrite the insured's life insurance policy while taking into account the insured's current medical condition, wherein the insured has an impaired life.

23. The method of claim 18, wherein the life expectancy of the insured is calculated by a method comprising:
determining the insured's current age;
determining the sex of the insured;
determining the present medical condition of the insured;
identifying the presence or absence of medical conditions among at least one member of insured's family; and
identifying the presence or absence of life-style choices previously made by the insured that are statistically linked to adverse medical conditions.

24. The method of claim 1, wherein at least one of the first and second entities is licensed to issue annuities.

25. The method of claim 1, wherein at least one of the first and second entities is a licensed and rated insurer.

26. The method of claim 1, wherein at least a portion of the periodic payments are: based on a fixed rate of return.

27. The method of claim 26, wherein the fixed rate of return is a guaranteed rate of return.

28. The method of claim 1, wherein at least a portion of the periodic payments are based on a variable rate of return.

29. The method of claim 28, wherein the variable rate of return is based on the performance of at least one of a portfolio of investment securities and the prevailing interest rate.

30. The method of claim 1, further comprising:
recording the formation of an agreement with a fourth entity, wherein the fourth entity will pay at least one of the first and second entities a lump-sum at the expiration of a time period during the life of the insured.

31. The method of claim 1, further comprising:
recording the formation of an agreement with a fourth entity, wherein the fourth entity will pay the first entity a lump-sum at the expiration of a time period during the life of the insured

32. The method of claim 1, further comprising: causing the formation of an agreement with a fourth entity, wherein the fourth entity will assume responsibility for paying the premium payment obligations of the insured's life insurance policy and assume responsibility for the payment of at least some of the periodic payments.

33. The method of claim 1, wherein one of the owner and the third entity is the insured, further comprising:
paying at least a portion of the periodic payments to the insured with a check made payable to the insured, and identifying a likelihood of an insured's death based on the absence of a timely cashed check.

34. The method of claim 33, wherein the absence of a timely cashed check is determined based on at least one of historic data of the number of days after mailing of the check that the insured cashes the check and a predetermined time period.

35. The method of claim 1, wherein one of the owner and the third entity is the insured, further comprising:
paying at least a portion of the periodic payments to the insured with a check made payable to the insured, and identifying a likelihood of an insured's death based on the signature on the check representing the endorser's signature.

36. A computer based method for investing, comprising:
estimating the payments that would be received by the owner of a life insurance policy from a plurality of options, the plurality of plurality of options comprising:
selling the life insurance policy in exchange for a life settlement; and
causing the formation of an agreement for the transfer of benefits of an insured's life insurance policy to a first entity, and the transfer of premium payment obligations of the insured's life insurance policy to the first entity or a second entity in exchange for periodic payments for a period of time to at least one of an owner of the life insurance policy and a third entity, wherein the period of time is based on at least one of a fixed period and the life of the insured; and
evaluating the differences between the payments that would be received by an insured from a plurality of options.

37. The method of claim 36, wherein the plurality of options also comprises surrendering the life insurance policy.

38. The method of claim 37, the plurality of options also comprises allowing the life insurance policy to lapse.

39. The method of claim 36, wherein the plurality of options also comprises allowing the life insurance policy to be maintained and further comprises evaluating the effect of at least one of estate taxes, the absence of estate taxes, income taxes, and the absence of income taxes, on monies resulting from payments resulting from the selection of one or more of the options.

40. A computer system, comprising:
a computing unit programmed with logic to determine the general amount of each payment in a group of periodic payments to be made for the life of an insured payable to a first entity based on:
the benefits of an insured's life insurance policy; and
the premium payment obligations of the insured's life insurance policy.

41. The computer system of claim 40, wherein the logic to determine the general amount of each payment in a group of periodic payments to be made for the life of an insured payable to a first entity is further based on the life expectancy of the insured.

42. The computer system of claim 41, wherein the life expectancy of the insured is based on the rated age of the insured.

43. The computer system of claim 40, further comprising logic to determine the general amount of a lump-sum payment to be made to the first entity or a second entity based on:
the benefits of an insured's life insurance policy; and
the premium payment obligations of the insured's life insurance policy.

44. The computer system of claim 43, wherein the logic to determine the general amount of a lump-sum payment to be made to the first entity or the second entity is further based on the life expectancy of the insured.

45. The computer system of claim 40, wherein the logic to determine the general amount of each payment in,a group of periodic payments to be made for the life of an insured to the first entity includes algorithms to increase or decrease the general amount of each payment over time.

46. The computer system of claim 40, further comprising logic to direct payment of at least one payment in the group of periodic payments to at least the first entity.

47. The computer system of claim 40, further comprising logic to direct payment of at least one payment in the group of periodic payments to a second entity.

48. The computer system of claim 47, further comprising logic to direct payment of at least one payment in the group of periodic payments to the first entity and then to direct payment of at least one payment in the group of periodic payments to the second entity.

49. The computer system of claim 43, further comprising logic to direct payment of the lump-sum payment to the first entity or a second entity.

50. The computer system of claim 40, further comprising logic to track the time between the date of mailing of a check representing a payment in the group of periodic payments and the date that the check was cashed.

51. The computer system of claim 50, further comprising logic to identify a likelihood of an insured's death based on a comparison of the time between the date of mailing of the check and the date that the check was cashed and at least one of a historical time between the date of mailing of a check representing a payment in the group of periodic payments and the date that the check was cashed and a predetermined time.

52. The computer system of claim 40, further comprising a computer to execute the computer system.

53. A computer readable medium having program code recorded thereon that causes, when executed, a computing system to:
calculate the general amount of each payment in a group of periodic payments to be made for the life of an insured payable to a first entity based on:
the benefits of an insured's life insurance policy; and
the premium payment obligations of the insured's life insurance policy.

54. The computer readable medium of claim 53, wherein the calculation of the general amount of each payment in a group of periodic payments to be made for the life of an insured payable to a first entity is further based on the life expectancy of the insured.

55. The computer readable medium of claim 54, the life expectancy of the insured is based on the rated age of the insured.

56. A method of investing, comprising:
inputting information into a computer terminal located in a first region, the information relating to the formation of an agreement for the for the transfer of benefits of an insured's life insurance policy to a first entity and the transfer of premium payment obligations of the insured's life insurance policy to the first entity or a second entity in exchange for periodic payments for a period of time to at least one of an owner of the life insurance policy and a third entity, wherein the period of time is based on at least one of a fixed period and the life of the insured;
transferring the information to a computer located in a second region.

57. The computer system of claim 33, wherein the lump-sum payment to be made to the first entity or a second entity is further based on current interest rates.

58. A computer implemented method for investing, comprising:
causing the formation of an agreement for the transfer of benefits of an insured's life insurance policy to a first entity in exchange for periodic payments for a period of time to at least one of an owner of the life insurance policy and a third entity, wherein the period of time is based on at least one of a fixed period and the life of the insured.

59. The method of claim 58, further comprising the transfer of premium payment obligations of the insured's life insurance policy.

60. The method of claim 57, wherein there is no transfer of premium payment obligations of the insured's life insurance policy.

61. The method of claim 60, wherein an escrow account is set up to pay the premium payment obligations of the insured's life insurance policy.

62. The method of claim 60, wherein at least one of an owner of the life insurance policy and a third entity pays into an escrow account that is set up to pay the premium payment obligations of the insured's life insurance policy in the event that the premium payments are not made by the owner.

63. The method of claim 1, wherein, under the agreement, the benefits of a plurality of insured's life insurance policies are transferred to a first entity and the premium payment obligations of the plurality of insured's life insurance policies are transferred to the first entity or the second entity in exchange for periodic payments for a period of time to at least one of an owner of the plurality of life insurance policies and a third, entity, wherein the period of time is based on at least one of a fixed period and the lives of the insured.

64. The method of claim 1, wherein the plurality of life insured policies are owned by the same entity.
